(19) United States
(12) Patent Application Publication
(10) Pub. No.: US 2010/0090113 A1
(43) Pub. Date: Apr. 15, 2010

(54) METHOD AND APPARATUS FOR RETRIEVING INFORMATION FROM OPTICAL STORAGE MEDIUM

(75) Inventor: Toshio SASAKI, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/578,828

(22) Filed: Oct. 14, 2009

(30) Foreign Application Priority Data
Oct. 14, 2008 (JP) 2008-265247

(51) Int. Cl. G01T 1/20

(52) U.S. Cl. 250/362; 250/363.01

(57) ABSTRACT

To retrieve information from an optical storage medium having a recording layer in which binary information is recorded in a form of presence or absence of a fluorescing property, the recording layer is illuminated with a light beam in a linearly polarized state, to induce fluorescence in the recording layer. Fluorescent light is isolated from light reflected in the optical storage medium by a polarized light separation element attenuating a linearly polarized component (including the light reflected in the optical storage medium) of the light coming from the optical storage medium, and the fluorescent light derived from the induced fluorescence is detected by a photosensor, which outputs a signal bearing the binary information recorded in the recording layer.

### CROSS-REFERENCE TO RELATED APPLICATION(S)

This application claims the foreign priority benefit under Title 35, United States Code, §119 (a)-(d), of Japanese Patent Application No. 2008-265247, filed on Oct. 14, 2008 in the Japan Patent Office, the disclosure of which is herein incorporated by reference in its entirety.

### BACKGROUND OF THE INVENTION

1. Field of the Invention

This invention relates to methods and apparatuses for retrieving information from an optical storage medium in which information is recorded using a potential fluorescing property of its material.

2. Description of Related Art

Optical storage media may be made of materials of a particular type which can be changed by application of light into those which possess fluorescing properties. This type of materials is presently known in the art, for example, as disclosed in WO 98/25262. When such an optical storage medium in which binary information is recorded in the form of arrangement of fluorescent and non-fluorescent sites is illuminated with a laser beam to retrieve the information therefrom, the laser beam induces fluorescence selectively in the fluorescent sites only, and the induced fluorescence is detected. However, light coming from the optical storage medium is not only the fluorescent light from the fluorescent sites but includes light reflected at interfaces between a recording layer and a layer adjacent thereto and between other adjacent layers. The light reflected as such, if detected, should be regarded as a background noise to be discriminated or isolated from a signal derived from the fluorescence.

For example, in a multilayer optical storage medium, the intensities of light at the recording layer are as follows.

Iᵣ=Iₘ·β

I_{f}=Iₘ·α·η_{F}·γ

where Iᵣ is the intensity of reflected light, I_{f} is the intensity of fluorescent light, α is the average absorptivity of the recording layer, β is the reflectivity of the recording layer, η_{F} is the fluorescence efficiency (fluorescence quantum yield) that is the ratio of fluorescent light to the light absorbed in the recording layer (normally, η_{F} is on the order of 0.8), γ is the coupling ratio that is the ratio of light collected by a recording objective lens to the fluorescent light emitted. It is assumed that the fluorescent light emitted from the recording spots (fluorescent sites) radiates with its intensity dispersed uniformly in every direction, and thus γ is determined by the NA of the recording objective lens; that is, γ is on the order of NA²/4.

The ratio of the intensity of the fluorescent light to that of the reflected light is:

I_{f}/Iᵣ=α·η_{F}·NA²/(4·β)

It is shown that, normally, η_{F}·NA²/4 is smaller than 1, and therefore, if α and β are substantially comparable to each other, then the intensity of the fluorescent light (i.e., the signal to be detected) is always smaller than the reflected light, which means that detection of the signal (fluorescent light) is difficult.

Thus, when a fluorescent light signal is to be detected from a multilayer optical storage medium, a recording layer and an intermediate layer provided therein should have indices of refraction between which a gap is minimized to materially reduce reflection of light applied for retrieval (α>>β).

The reflection of light may easily be removed if an optical storage medium of a “bulk” type is adopted which has no intermediate layer and thus has no interface between a recording layer and an intermediate layer. However, the bulk type optical storage medium would disadvantageously require a more complicated servo control to ensure the precise positioning in a depth direction for recording.

In cases where an optical storage medium which has an intermediate layer and in which reflections should thus occur is used, if the peak shift (Stokes shift) of fluorescence emission spectrum is great, then the induced fluorescent light can be separated from the reflected light of the light applied for retrieval, by a filter having a cutoff frequency corresponding to a cutoff wavelength between the wavelength of the light applied for retrieval and the peak wavelength of the fluorescent light. However, if the peak shift is small, then such separation should be difficult, and thus the fluorescent light could not be detected. Moreover, since the absorption-fluorescence spectrum varies in accordance with recording materials, the cutoff characteristics (cutoff wavelength) of the filter would disadvantageously need to be changed in accordance with a recording material used.

As described above, there is a need to provide a method and an apparatus for retrieving information from an optical storage medium in which information is recorded using a potential fluorescing property of its material, wherein it is ensured that reflected light and fluorescent light can be separated irrespective of the magnitude of the Stokes shift, to increase the signal-to-noise (S/N) ratio of the detected signal of the fluorescent light. The present invention has been made against this backdrop.

### SUMMARY OF THE INVENTION

It is one aspect of the present invention to provide a method for retrieving information from an optical storage medium having a recording layer in which binary information is recorded in a form of presence or absence of a fluorescing property. The method comprises: illuminating the recording layer with a light beam, to induce fluorescence in the recording layer; isolating fluorescent light derived from the induced fluorescence, from light received from the optical storage medium; and causing a photosensor to detect the isolated fluorescent light, to output a signal bearing the binary information recorded in the recording layer. The step of isolating the fluorescent light comprises causing a polarized light separation element to attenuate a linearly polarized component of the light reflected in the optical storage medium.

The reflected light derived from the light beam reflected in the optical storage medium, which includes, for example, light reflected at interfaces between adjacent layers (e.g., between the recording layer and a layer adjacent thereto) by virtue of difference in the index of refraction therebetween, returns in the form of linearly polarized light, while the fluorescence induced in the recording layer is unpolarized, i.e., a light wave whose direction of polarization changes randomly and which may thus include waves oriented in any direction. Therefore, the reflected light can be attenuated by the polarized light separation element attenuating a linearly polarized component in a mixture of the reflected light and the fluorescent light.

Accordingly, the ratio of the intensity of the fluorescent light (signal) to the intensity of the reflected light can be increased so that the S/N ratio of the fluorescent light signal can be improved.

In the above-described method, preferably but not necessarily, the step of isolating fluorescent light may further comprise causing a polarizer to attenuate a linearly polarized component of light received from the polarized light separation element, which may be part of the reflected light. With this additional feature, the intensity of the fluorescent light relative to the intensity of the reflected light in the light received by the photosensor can be increased more.

In the above-described method, the recording layer for use in the optical storage medium may, preferably but not necessarily, be selected from those which comprise a material in which a multiple photon absorption reaction occurs upon irradiation with light, the multiple photon absorption reaction causing the material to change from a state without the fluorescing property to a state with the fluorescing property.

In the above-described method, the light beam used in illuminating the recording layer to retrieve the information therefrom may, preferably but not necessarily, have a wavelength different from that of a light beam used to record the information in the recording layer of the optical storage medium. With this additional feature, the recording layer is not easily caused to change during the process of retrieving information, and thus a sufficiently intense light beam can be applied to retrieve information from the fluorescent light signal at a high S/N ratio.

In another aspect of the present invention, there is provided an apparatus for retrieving information from an optical storage medium having a recording layer in which binary information is recorded in a form of presence and absence of a fluorescing property. The apparatus comprises a light source, an illumination optical system, a beam splitter, a retrieval optical system, and a polarized light separation element. The light source is configured to emit a light beam in a linearly polarized state. The illumination optical system is configured to converge the light beam emitted by the light source, into the recording layer of the optical storage medium, to induce fluorescence in the recording layer. The beam splitter is provided on a light path of the illumination optical system, and configured to cause a light beam coming from the optical storage medium to be deviated from the light path of the illumination optical system. The retrieval optical system is disposed to receive and converge the light beam deviated at the beam splitter. The retrieval optical system comprises a photosensor configured to detect fluorescent light derived from the induced fluorescence, in the light beam received and converged in the retrieval optical system, and to output a signal bearing the binary information recorded in the recording layer. The polarized light separation element is provided in at least one of the illumination optical system and the retrieval optical system, and configured to attenuate reflected light derived from the light beam reflected in the optical storage medium, before the photosensor receives the fluorescent light.

According to the apparatus configured as described above, like the above-described method aspect of the present invention, the fluorescent light can be separated from the reflected light by the polarized light separation element, so that the S/N ratio of the fluorescent light signal can be improved.

The above-described apparatus may, preferably but not necessarily, further comprise a polarizer disposed downstream of the polarized light separation element on a path of the fluorescent light, and configured to further attenuate the reflected light. The above-described apparatus may further comprise a recording light source configured to emit a light beam for recording, and a recording optical system configured to converge the light beam emitted by the recording light source, into the recording layer of the optical storage medium, to record the information therein. The light beam emitted by the light source to retrieve the recorded information may have a wavelength different from that of the light beam emitted by the recording light source to record the information in the recording layer of the optical storage medium, so that a sufficiently intense light beam can be applied to retrieve information from the fluorescent light signal at a high S/N ratio because the recording layer is not easily caused to change during the process of retrieving information.

The above-described apparatus may, preferably but not necessarily, comprise a member having a pinhole disposed in a position short of the photosensor and in vicinity of a focal point of the light beam converged in the retrieval optical system. With this additional feature, the reflected light that goes out of focus in the pinhole can be interrupted by the member having the pinhole, so that the S/N ratio of the fluorescent light signal can be improved further.

According to the aspects and some additional features of the present invention, which may be embodied in a method and an apparatus for retrieving information from an optical storage medium as will be described below, it is ensured that reflected light and fluorescent light can be separated irrespective of the magnitude of the Stokes shift, to increase the signal-to-noise ratio of the detected signal of the fluorescent light, by making use of the polarized light separation element which is configured to attenuate light reflected in the optical storage medium.

### BRIEF DESCRIPTION OF THE DRAWINGS

The above aspects and advantages, other advantages and further features of the present invention will become more apparent by describing in detail illustrative, non-limiting embodiments thereof with reference to the accompanying drawings, in which:

FIG. 1 is a schematic diagram showing an optical disc drive as one example of an apparatus for retrieving information from an optical storage medium according to a first embodiment of the present invention;

FIG. 2 is a sectional view of an optical disc as one example of an optical storage medium;

FIG. 3 is a schematic diagram for explaining a path along which light travels to record information in the optical disc drive according to the first embodiment;

FIG. 4 is a schematic diagram for explaining a path along which light travels to retrieve information from the optical disc drive according to the first embodiment;

FIG. 5 is a schematic diagram showing an optical disc drive as one example of an apparatus for retrieving information from an optical storage medium according to a second embodiment of the present invention;

FIG. 6 is a schematic diagram for explaining a path along which light travels to record information in the optical disc drive according to the second embodiment;

FIG. 7 is a schematic diagram for explaining a path along which light travels to retrieve information from the optical disc drive according to the second embodiment;

FIG. 8 is a diagram showing a modified arrangement of the first embodiment;

FIG. 9 is a diagram showing a modified arrangement of the second embodiment;

FIG. 10 shows a characteristic curve of a high-pass filter;

FIG. 11 shows a characteristic curve of a band-pass filter; and

FIG. 12 is a diagram showing a modified arrangement of the first embodiment in which a polarizer is disposed in a position different from that of the first embodiment.

### DETAILED DESCRIPTION OF EXEMPLARY EMBODIMENTS

To give a detailed description of some exemplary embodiments of the present invention, optical disc drives or optical disc readers/writers and methods for recording and retrieving data (information) using such an optical disc drive, each designed in a manner consistent with the present invention, will be described hereinafter. In the following description, each of the optical disc drives (hereinafter referred to simply as “apparatus”) is taken as an example of an apparatus for retrieving information from an optical storage medium according to one exemplary embodiment of the present invention, and it is thus to be understood that its recording function is optional in view of the present invention.

### First Embodiment

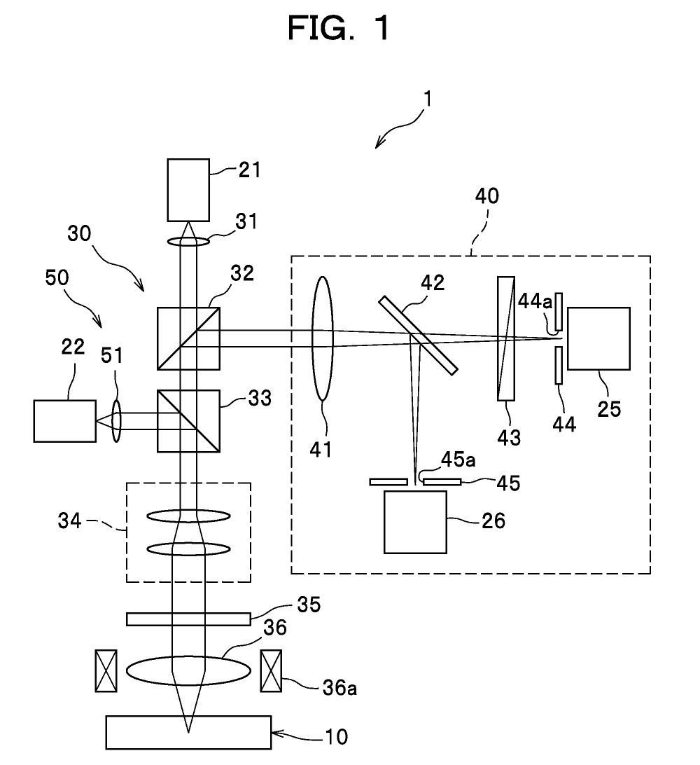

An apparatus and a method for recording and retrieving information as designed in accordance with a first embodiment of the present invention will be described with reference to FIGS. 1-4.

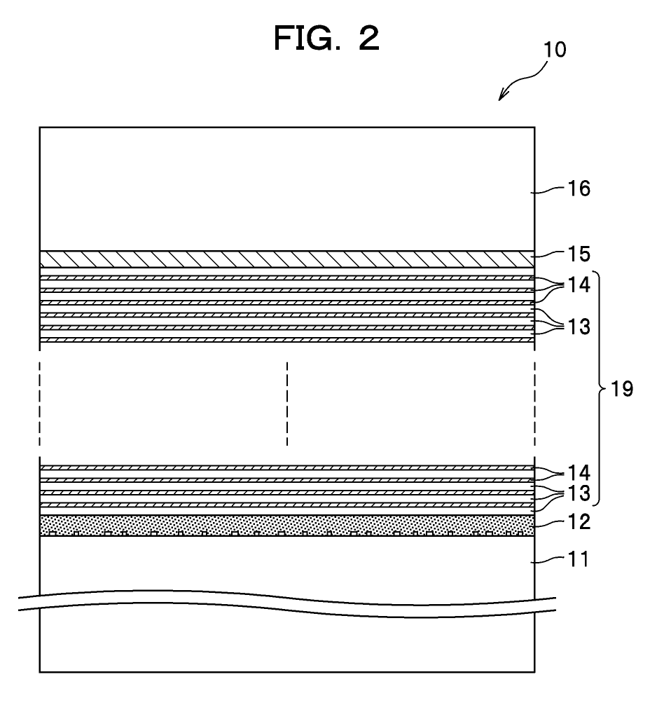

At the outset, referring to FIG. 2, an optical storage medium (optical disc) 10 in which information is to be recorded by an apparatus (optical disc drive) 1 and from which information is to be retrieved by the apparatus 1 is described. As shown in FIG. 2, the optical storage medium 10 comprises a substrate 11, a servo signal layer 12, a plurality of alternating intermediate layers 13 and recording layers 14, a light-shield filter layer 15, and a cover layer 16.

The substrate 11 is a circular plate made of a polycarbonate or like material and configured to support the recording layers 14.

The servo signal layer 12 is made of a viscous or adhesive resin material which serves to retain the intermediate layers 13 and the recording layers 14 on the substrate 11. The servo signal layer 12 has a servo signal prerecorded on a side thereof facing to the substrate 11 in a series of pits and projections or a pattern of variations in refractive index. The servo signal is a predetermined signal for use in the apparatus 1 to locate a reference plane for focusing during its recording and retrieving processes. To be more specific, the apparatus 1 is configured to adjust a focus with consideration given to the distance from the reference plane, in order to focus a laser beam into a specific recording layer 14. Alternatively or additionally, a servo signal for tracking control may be recorded on the servo signal layer 12 so that a laser beam can accurately follow a track of recording spots arranged circumferentially in the recording layers 14, during the recording and retrieving processes.

Each recording layer 14 is made of a photosensitive material in which information is optically recordable. In the present embodiment, irradiation of the recording layer 14 with a recording laser beam (light beam for recording) induces a two-photon absorption reaction in the irradiated material of the recording layer 14, which in turn causes the material to change from a state without a fluorescing property to a state with a fluorescing property. The photosensitive material which can be used for the recording layer 14 includes, for example, a recording material adopted as Sample 3 in the third Example disclosed in JP 2005-320502 A, the content of which is herein incorporated by reference in its entirety. The number of the recording layers 14 may be on the order of 1 to 100. It is desirable to provide as many the recording layers 14 as possible to increase the storage capacity of the optical storage medium 10; for example, more than ten recording layers may preferably be provided.

The thickness of each recording layer 14 may preferably but not necessarily be 1 micrometer or less. This is because the excessive thickness of the recording layer causes fluorescence induced during the retrieving process to be dispersed too deeply in the direction of thicknesses of the recording layers, and thus a crosstalk in signals detected during the retrieving process between the recording layers could disadvantageously be observed.

Each intermediate layer 13 is interposed between adjacent recording layers 14. The intermediate layer 13 is made of a material which is not changed by irradiation with a laser beam applied during the recording and retrieving processes. The intermediate layers 13 are provided to keep a predetermined space between the adjacent recording layers 14, so that interlayer crosstalk between the recording layers 14 can be prevented. The material which can be used for the intermediate layer 13 includes, for example, a composition containing a polymer having a glass transition temperature Tg not higher than ambient temperature, as produced by loosely cross-linking with isocyanate a polymer of a molecular weight not lower than 100,000 comprising polyvinyl alcohol, acrylic acid and acrylic ester. Hereinafter, a layer composed of a plurality of alternate intermediate layers 13 and recording layers 14 will be referred to as composite layer 19 where appropriate for convenience of explanation. It is to be noted that no intermediate layer 13 is required if only one recording layer 14 is provided.

The thickness of each intermediate layer 13 may preferably but not necessarily be 20 micrometer or less so that the greatest possible number of recording layers 14 can be provided, and be 5 micrometer or more so that the interlayer cross talk which would otherwise occur between adjacent recording layers 14 can be prevented.

The light-shield filter layer 15 is provided on the composite layer 19 and configured to absorb or reflect light of wavelengths unnecessary for recording or retrieval of information so as to attenuate the same. The light-shield filter layer 15 may be provided for the purpose of preventing the deterioration of the recording layers 14 due to long-term exposure to the unnecessary light.

The cover layer 16 is provided to protect the composite layer 19, and made of a material capable of transmitting a laser beam applied during the recording and retrieving processes. The cover layer 16 may have an appropriate thickness in the range of several tens of micrometers to several millimeters.

The optical storage medium 10 configured as described above is intended to be a medium in which a signal (binary information) is recorded in a form of presence or absence of a fluorescing property.

Next, a specific configuration of the apparatus 1 is described with reference to FIG. 1. As shown in FIG. 1, the apparatus 1 principally includes a laser 21 for retrieval as one example of a light source configured to emit a light beam for use in retrieval of information, an illumination optical system 30 configured to converge a laser beam emitted by the laser 21, into the recording layer 14 (see FIG. 2) of the optical storage medium 10, a retrieval optical system 40 configured to detect fluorescence induced in the recording layer 14 and to detect reflected light reflected in the optical storage medium 10 for the purpose of servo control over the laser beam, a laser 22 for recording as one example of a recording light source configured to emit a light beam for recording, and a recording optical system 50 configured to converge a laser beam emitted by the laser 22, into the recording layer 14 of the optical storage medium 10.

The laser 21 for retrieval is a known device that produces a laser beam in a linearly polarized state. The wavelength of the laser beam emitted from the laser 21 may preferably be set appropriately in a range of 400 to 680 nanometers.

The illumination optical system 30 has optics arranged to converge a laser beam emitted by the laser 21, into the recording layer 14 of the optical storage medium 10, and principally includes a collimating lens 31, a beam splitter 32, a dichroic mirror 33, a beam expander 34, a quarter-wave plate 35, and an objective lens 36.

The collimating lens 31 is a lens located downstream of the laser 21 along a path to be traveled by a laser beam emitted for retrieval, and configured to convert the laser beam emitted from the laser 21 into a nearly parallel beam. Here, in describing the illumination optical system 30, the term “downstream” or “upstream” is used to indicate a relative position with respect to the direction in which a laser beam to be applied for retrieval travels from the laser 21 toward the optical storage medium 10.

The beam splitter 32 is an optical element located downstream of the collimating lens 31 along the path to be traveled by a laser beam emitted for retrieval, and configured to reflect a light beam (including part of fluorescent light emitted from the recording layer 17 and part of reflected light returned from the optical storage medium 10) in a direction deviated sideward from the path of a laser beam traveling from the laser 21 toward the optical storage medium 10 for retrieval of information.

The dichroic mirror 33 is a mirror which reflects light selectively, only in a specific range of wavelengths. The dichroic mirror 33 is configured to reflect a laser beam emitted for recording and to transmit a laser beam emitted for retrieval. In the present embodiment, the dichroic mirror 33 is disposed to receive the laser beam for recording from sideward and to direct the same toward the optical storage medium 10.

The beam expander 34 is located downstream of the dichroic mirror 33 along the path to be traveled by a laser beam emitted for retrieval, and composed of a group of lenses arranged to enlarge the diameter of the laser beam emitted for retrieval.

The quarter-wave plate 35 is an optical element located downstream of the beam expander 34 along the path to be traveled by a laser beam emitted for retrieval, and configured to convert linearly polarized light to circularly polarized light and to convert circularly polarized light to linearly polarized light having a plane of vibration of electric field vector oriented in accordance with the direction of rotation of electric field vector of the circularly polarized light.

The objective lens 36 is a lens located downstream of the quarter-wave plate 35 along the path to be traveled by a laser beam emitted for retrieval, and configured to converge the laser beam into one of the recording layers 14. The objective lens 36 is actuated by a focus actuator 36a to move in an optical axis thereof along which the laser beam travels, so that the laser beam can be focused on an adequate spot in a specific recording layer 14.

The retrieval optical system 40 is located outside the illumination optical system 30 and downstream along a path of a light beam deviated sideward from the light path of the illumination optical system 30 by the beam splitter 32, and comprises a photosensor 25 for signal retrieval, a photosensor 26 for reflected light, a condenser lens 41, a semitransparent mirror 42, a polarizer 43, and pinhole plates 44, 45. Here, in describing the retrieval optical system 40, the term “downstream” or “upstream” is used to indicate a relative position with respect to the direction in which a laser beam deviated from the light path of the illumination optical system 30 travels from the beam splitter 32 toward the photosensor 25 and the photosensor 26.

The photosensor 25 for signal retrieval is a light-sensitive detector configured to detect fluorescent light derived from fluorescence induced at spots in the recording layer 14 where the fluorescing property is present, to provide a signal bearing the binary information recorded in the recording layer 14.

The photosensor 26 for reflected light is a light-sensitive detector configured to detect reflected light that is light reflected in the optical storage medium 10. To be more specific, the reflected light to be detected by the photosensor 26 is light reflected at an interface between the recording layer 14 to which a laser beam is applied for retrieval and one of two adjacent intermediate layers 13 because the light at this interface is considered to be of the highest intensity.

The condenser lens 41 is a lens located downstream along the path of a light beam deviated from the light path of the illumination optical system 30 by the beam splitter 32, and configured to focus the light beam on a spot located in close vicinity of the photosensor 25 and a spot located in close vicinity of the photosensor 26.

The semitransparent mirror 42 is located downstream along the path of a light beam that has passed through the condenser lens 41, and configured to transmit one part of the light beam (first beam) and to reflect another part of the light beam (second beam) in a direction deviated sideward from the path. The aforementioned photosensor 25 for signal retrieval is located on a path of the first beam that has passed straight through the semitransparent mirror 42, while the aforementioned photosensor 26 for reflected light is located on a sideward-deviated path of the second beam that has been reflected in the semitransparent mirror 42.

The polarizer 43 is one example of a polarized light separation element, and is located downstream of the semitransparent mirror 42 along the path of the first beam that has passed straight through the semitransparent mirror 42. The direction of the transmission axis of the polarizer 43 (the orientation of the plane of vibration of electric field vector of the polarized light that will pass through the polarizer 43) is perpendicular to the orientation of the plane of vibration of electric field vector of the reflected light, and thus the reflected light is considerably attenuated. On the other hand, since the fluorescent light derived from fluorescence induced in the recording layer 14 is unpolarized, half of the fluorescent light incident thereon will pass through the polarizer 43.

The optical loss of the reflected light caused by the polarizer 43 (polarized light separation element) may preferably but not necessarily be not lower than 20 dB.

The pinhole plate 44 is one example of a member having a pinhole 44a, and is disposed in a position short of the photosensor 25 for signal retrieval, that is, upstream of the photosensor 25 for signal retrieval along the path of the first beam that has passed straight through the semitransparent mirror 42 and the polarizer 43 toward the photosensor 25 for signal retrieval. The pinhole 44a of the pinhole plate 44 is located in a position on the path of the fluorescent light that has passed through the polarizer 43 and in close vicinity of the focal point thereof, or preferably exactly at the focal point. In this way, a component of the light that has passed through the polarizer 43 but failed to come into focus within the pinhole 44a will be interrupted by the pinhole plate 44, and thus the S/N ratio of the detected signal of the fluorescent light is increased.

The pinhole plate 45 having a pinhole 45a is disposed in a position short of the photosensor 26 for reflected light, that is, upstream of the photosensor 26 for reflected light along the path of the second beam that has been reflected in the semitransparent mirror 42 sideward toward the photosensor 26. The pinhole 45a of the pinhole plate 45 is located in a position on the path of the second beam that has been reflected from the semitransparent mirror 42 and in close vicinity of the focal point thereof, or preferably exactly at the focal point. In this way, a component of the light that has been reflected from the semitransparent mirror 42 but failed to come into focus within the pinhole 45a will be interrupted by the pinhole plate 45, and thus the S/N ratio of the detected signal of the reflected light (light reflected in the optical storage medium 10) is increased.

The laser 22 for recording is a known device that produces a laser beam in a linearly polarized state. The wavelength of the laser beam emitted from the laser 22 may preferably be set appropriately in a range of 400 to 540 nanometers. In this embodiment, since the dichroic mirror 33 utilizes its wavelength selectivity in reflection, the laser 22 for recording is configured to emit a light beam having a wavelength different from that of the light beam emitted by the laser 21 for retrieval.

The recording optical system 50 is configured to converge a light beam for recording, that is, a light beam emitted by the laser 22 for recording, into the recording layer 14 of the optical storage medium 10. The recording optical system 50 includes a collimating lens 51 which is a lens configured to convert the laser beam emitted from the laser 22 for recording, into a nearly parallel beam. The laser beam for recording that has passed through the collimating lens 51 is caused to enter the dichroic mirror 33, and directed toward the optical storage medium 10. In this sense, the dichroic mirror 33 and the elements that follow, such as the beam expander 34, quarter-wave plate 35 and objective lens 36, serve as components of the recording optical system 50 as well as the illumination optical system 30.

Although not shown in the drawing figures, each component described above operates under control of a controller. There are also provided a spindle for holding and rotating the optical storage medium 10 and an actuator for moving the optical storage medium 10 and/or the laser beam (emitted for recording and for retrieval), relative to each other, in a radial direction of the optical storage medium 10, and the spindle and the actuator operate under control of the controller. In this way, information can be recorded on an entire surface of each recording layer 14 of the optical storage medium 10, and information can be retrieved from the entire surface of each recording layer 14 of the optical storage medium 10.

The next discussion is directed to an operation of the apparatus 1 (optical disc drive for recording and retrieving information in an optical disc as one example of an optical storage medium 10) configured as described above, and more specifically to a method for recording information in an optical storage medium 10 and a method for retrieving information from an optical storage medium 10 in which information is recorded.

### <Operation in Recording>

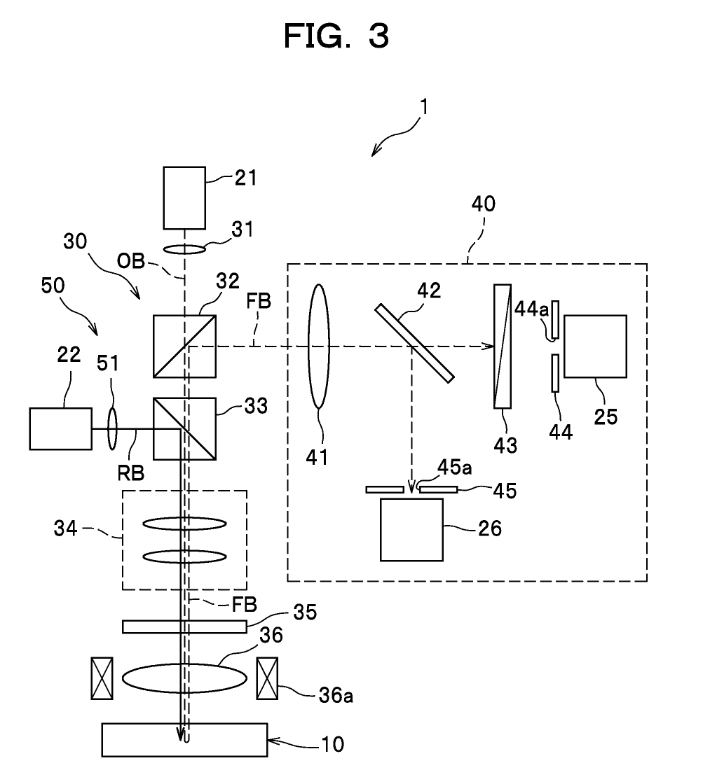

As shown in FIG. 3, when information is to be recorded, an operation, similar to that which is to be carried out when information is recorded on a CD-R, is carried out. That is, the controller causes the laser 22 to emit a laser beam RB for recording, while rotating an optical storage medium 10. The laser beam RB is pulsed in accordance with information to be recorded by a known modulation method. The laser beam RB passes through the collimating to lens 51, then reflects in the dichroic mirror 33, and travels toward the optical storage medium 10. Thereafter, the laser beam RB is expanded by the beam expander 34, converted into a circularly polarized light beam by the quarter-wave plate 35, and converged into a specific recording layer 14 by the objective lens 36.

While information is being recorded, the laser 21 for retrieval emits a laser beam OB. The laser beam OB is converted into a parallel beam by the collimating lens 31, passing through the beam splitter 32 and the dichroic mirror 33, and then expanded by the beam expander 34. Thereafter, the laser beam OB is converted into a circularly polarized light beam by the quarter-wave plate 35, and converged into the specific recording layer 14 by the objective lens 36.

Light reflected at an interface between the specific recording layer 14 and an intermediate layer 13 adjacent to this specific recording layer 14 (a light beam thus reflected will be referred to as reflected light beam FB) has a reversed direction of rotation of the electric field vector of its circular polarization, and travels backward a path along which the laser beam OB has traveled toward the recording layer 14. The reflected light beam FB passes through the objective lens 36 to become a parallel beam, and thereafter, passes through the quarter-wave plate 35 to become a linearly polarized light beam. Then, the reflected light beam FB passes through the beam expander 34 and the dichroic mirror 33, and is reflected sideward in the beam splitter 32.

Thereafter, the reflected light beam FB passes through the condenser lens 41, reflects off the semitransparent mirror 42, and enters the photosensor 26 for reflected light so that the reflected light beam FB is detected therein.

The photosensor 26 for reflected light thus detects reflected light, to output a signal to the controller. This signal indicative of the reflected light is used for focus servo control.

### <Operation in Retrieval>

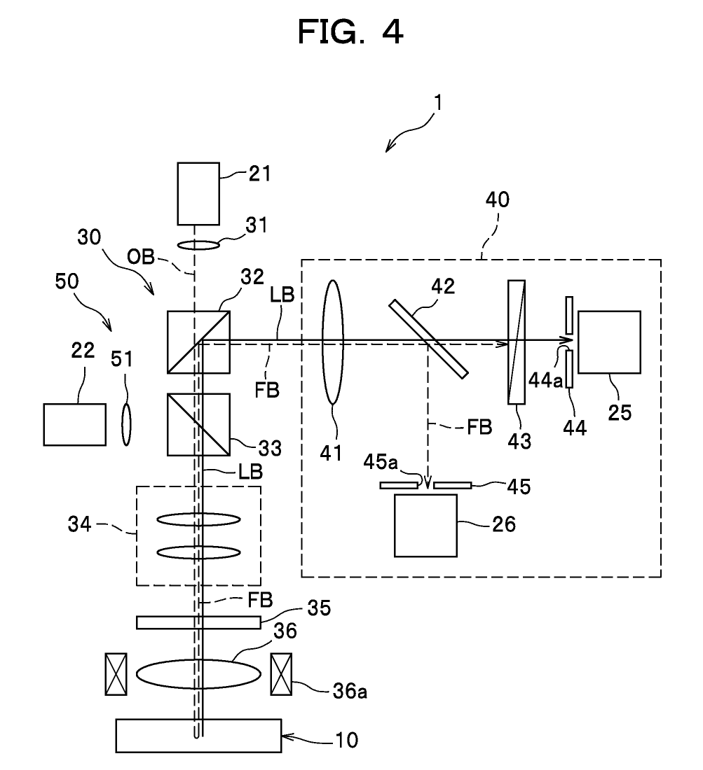

As shown in FIG. 4, when information is to be retrieved, the controller causes the laser 21 to emit a laser beam OB for retrieval, while rotating an optical storage medium 10 by the spindle. The laser beam OB passes through the beam splitter 32 and the dichroic mirror 33, and then is expanded by the beam expander 34, converted into a circularly polarized light beam by the quarter-wave plate 35, and converged into a recording layer 14 of the optical storage medium 10 by the objective lens 36. In the optical storage medium 10, information is recorded by modulation of the presence or absence of a fluorescing property. When the laser beam OB is applied to a spot in the recording layer 14 where the fluorescing property is present, fluorescence is induced. Meanwhile, part of the laser beam OB reflects at an interface between the recording layer 14 on which the laser beam OB is focused and an intermediate layer 13 adjacent to this recording layer 14, and the direction of rotation of the electric field vector of its circular polarization is reversed (a light beam thus reflected will be referred to as reflected light beam FB). Part of the induced fluorescence and the reflected light beam FB travel in a direction opposite to a direction in which the laser beam OB has traveled toward the recording layer 14, and reach the objective lens 36. The reflected light beam FB is rendered parallel while passing through the objective lens 36, and converted into a linearly polarized state while passing through the quarter-wave plate 35. The reflected light beam FB then passes through the beam expander 34 and the dichroic mirror 33, and is reflected in the beam splitter 32 in a direction deviated sideward. Similarly, the fluorescence is rendered parallel into a light beam while passing through the objective lens 36. This light beam derived from the fluorescence will be referred to as fluorescent light beam LB. The fluorescent light beam LB then passes through the quarter-wave plate 35 (with its unpolarized state unchanged), the beam expander 34 and the dichroic mirror 33, and is reflected in the beam splitter 32 in the same sideward-deviated direction.

The fluorescent light beam LB deviated sideward from the light path of the illumination optical system 30 passes through the condenser lens 41, and reaches the semitransparent mirror 42. At the semitransparent mirror 42, half of the fluorescent light beam LB passes straight therethrough, and enters the polarizer 43, in which half of the fluorescent light incident thereon passes therethrough. The fluorescent light beam LB having passed through the polarizer 43 comes into a focus at or near a position of the pinhole plate 44 and passes through the pinhole 44a and enters the photosensor 25 for signal retrieval. The photosensor 25 detects the fluorescent light beam LB and outputs a fluorescent light signal, which in turn is received by the controller in which information is demodulated therefrom by a known demodulation method.

On the other hand, the reflected light beam FB deviated from the light path of the illumination optical system 30 by the beam splitter 32 passes through the condenser lens 41, and reaches the semitransparent mirror 42 at which half of the reflected light beam FB passes straight therethrough. The reflected light beam FB having passed through the semitransparent mirror 42 strikes the polarizer 43, at which most of the reflected light beam FB is interrupted because the orientation of the plane of vibration of electric field vector of the reflected light beam FB is shifted by 90 degrees from the direction of the transmission axis of the polarizer 43. Half of the reflected light beam FB having failed to pass straight through the semitransparent mirror 42 reflects therefrom, comes into focus at or near a position of the pinhole plate 45, passes through the pinhole 45a, and enters the photosensor 26 for reflected light. The photosensor 26 detects the reflected light beam FB and outputs a reflected light signal, which in turn is received and utilized for focus servo control by the controller.

As described above, in the apparatus 1 according to the present embodiment, the reflected light beam FB and the fluorescent light beam LB enter the retrieval optical system 40 together, but the reflected light beam FB is attenuated by the polarizer 43 provided in the retrieval optical system 40. Therefore, the fluorescent light beam LB having passed through the polarizer 43 has an improved S/N ratio. Isolation of the fluorescent light beam LB from the reflected light beam FB is achieved without utilizing the Stokes shift of the recording material, and it is thus ensured that the fluorescent light beam LB and the reflected light beam FB can be separated irrespective of the recording material used for the recording layer 14.

### Second Embodiment

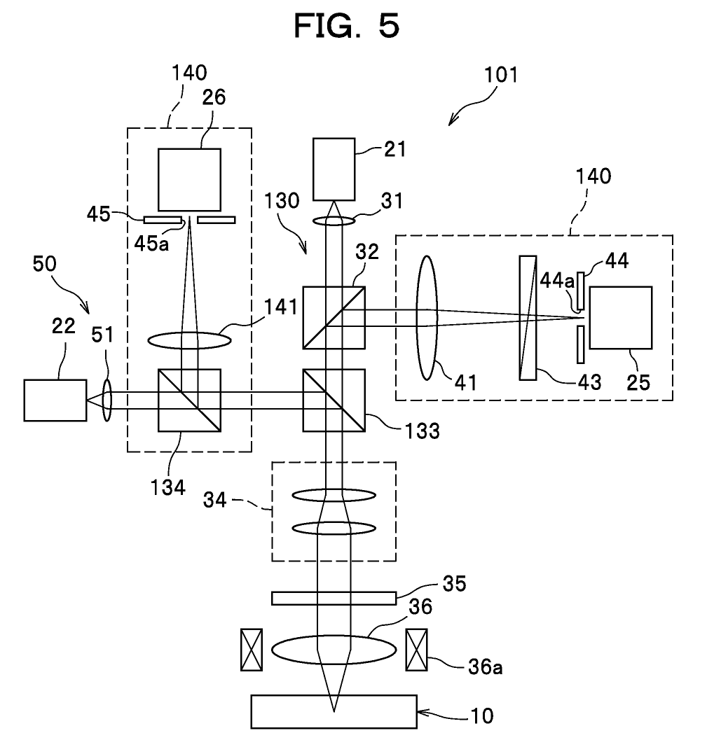

An apparatus and a method for recording and retrieving information as designed in accordance with a second embodiment of the present invention will be described with reference made mainly to FIGS. 5-7. In disclosing the second embodiment, the same elements will be designated by the same reference numerals in the drawings and a detailed description thereof will be omitted in the description.

The apparatus 101 according to the second embodiment is such that a polarized light beam splitter is adopted as a polarized light separation element. As shown in FIG. 5, an illumination optical system 130 comprises a polarized beam splitter 133, which is provided therein instead of the dichroic mirror 33 provided in the apparatus 1 of the first embodiment.

The polarized beam splitter 133 is an optical element located downstream of the beam splitter 32 along a path to be traveled by a laser beam emitted for retrieval, and configured to transmit a light beam in a linearly polarized state with a plane of vibration of electric field vector oriented in a specific direction, and to reflect a light beam in a linearly polarized state with a plane of vibration of electric field vector oriented in a direction perpendicular to the specific direction. In the present embodiment, the direction of the transmission axis of the polarized beam splitter 133 is oriented such that a laser beam emitted for recording and a reflected light beam coming back from the optical storage medium 10 are reflected, while a laser beam emitted for retrieval is transmitted straightforward.

Most of the reflected light beam coming from the optical storage medium 10 is reflected by the polarized beam splitter 133 in a direction deviated sideward; therefore, as far as the reflected light beam transmitted straightforward is concerned, the reflected light is considerably attenuated.

The apparatus 101 further comprises a dichroic mirror 134 located in a retrieval optical system 140, downstream along a path of a light beam deviated sideward from the light path of the illumination optical system 130 by the polarized beam splitter 133 toward the direction in which the most of the reflected light beam coming from the optical storage medium 10 is reflected. The laser 22 for recording is located in a specific position and orientation such that a laser beam emitted thereby for recording passes through the dichroic mirror 134 and the polarized beam splitter 133.

In the present embodiment, the polarized beam splitter 133 serves as the polarized light separation element. Therefore, provision of the polarizer 43 is optional. However, the provision of the polarizer 43 may be advantageous, in that the polarizer 43 can further attenuate the remaining component of the reflected light beam which has passed straight through the polarized beam splitter 133, so that the S/N ratio of the detected signal of the fluorescent light can be increased further. In this particular configuration, the direction of the transmission axis of the polarizer 43 and the direction of the transmission axis of the polarized beam splitter 133 may preferably be rendered optically conformable such that the linearly polarized component of light having the same orientation of the plane of vibration of electric field vector (i.e., as considered to be derived from the light reflected in the optical storage medium 10) can be attenuated in both of these optical elements 43 and 133.

The dichroic mirror 134 has a wavelength selectivity configured to transmit a laser beam emitted for recording and to reflect a laser beam emitted for retrieval and reflected in the optical storage medium 10. The apparatus 101 further comprises a condenser lens 141 located in the retrieval optical system 140, downstream of the dichroic mirror 134 along a path of a light beam reflected twice, i.e., in the polarized beam splitter 133 and in the dichroic mirror 134. The photosensor 26 for reflected light, in this embodiment, is also located in the retrieval optical system 140, downstream of the condenser lens 141, along the same path of the reflected light beam. The condenser lens 141 is a lens configured to focus the light beam on a spot located in close vicinity of the photosensor 26.

The next discussion is directed to an operation of the apparatus 101 configured as described above, and more specifically to a method for recording information in an optical storage medium 10 and a method for retrieving information from an optical storage medium 10 in which information is recorded.

### <Operation in Recording>

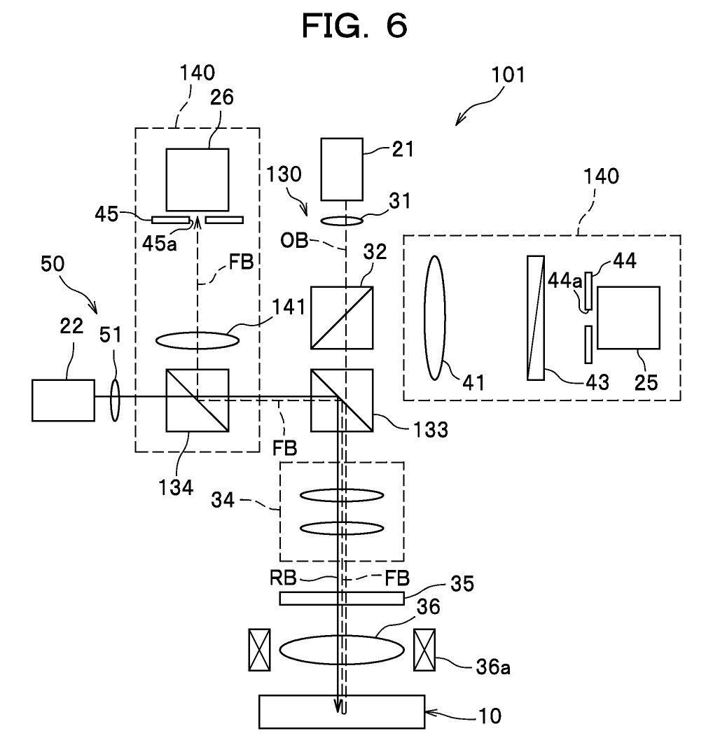

As shown in FIG. 6, when information is to be recorded, an operation, similar to that which is to be carried out when information is recorded on a CD-R, is carried out. That is, the controller causes the laser 22 to emit a laser beam RB for recording, while rotating an optical storage medium 10. The laser beam RB is pulsed in accordance with information to be recorded by a known modulation method. The laser beam RB passes through the collimating lens 51, then passes straight through the dichroic mirror 134, and travels toward the polarized beam splitter 133. The laser beam RB is reflected in the polarized beam splitter 133. Thereafter, the laser beam RB is expanded by the beam expander 34, converted into a circularly polarized light beam by the quarter-wave plate 35, and converged into a specific recording layer 14 by the objective lens 36.

While information is being recorded, the laser 21 for retrieval emits a laser beam OB. The laser beam OB is converted into a parallel beam by the collimating lens 31, passing through the beam splitter 32 and the polarized beam splitter 133, and then expanded by the beam expander 34. Thereafter, the laser beam OB is converted into a circularly polarized light beam by the quarter-wave plate 35, and converged into the specific recording layer 14 by the objective lens 36.

Light reflected at an interface between the specific recording layer 14 and an intermediate layer 13 adjacent to this specific recording layer 14 (a light beam thus reflected will be referred to as reflected light beam FB) has a reversed direction of rotation of the electric field vector of its circular polarization, and travels backward a path along which the laser beam for retrieval has traveled toward the recording layer 14. The reflected light beam FB passes through the objective lens 36 to become a parallel beam, and thereafter, passes through the quarter-wave plate 35 to become a linearly polarized light beam having a plane of vibration of electric vector oriented perpendicular to that of the laser beam OB. Then, the reflected light beam FB passes through the beam expander 34, and is reflected sideward in the polarized beam splitter 133.

Thereafter, the reflected light beam FB is further reflected sideward in the dichroic mirror 134 and converged by the condenser lens 141 to pass through the pinhole 45a, and enters the photosensor 26 for reflected light so that the reflected light beam FB is detected therein.

The photosensor 26 for reflected light thus detects reflected light, to output a signal to the controller. This signal indicative of the reflected light is used for focus servo control.

### <Operation in Retrieval>

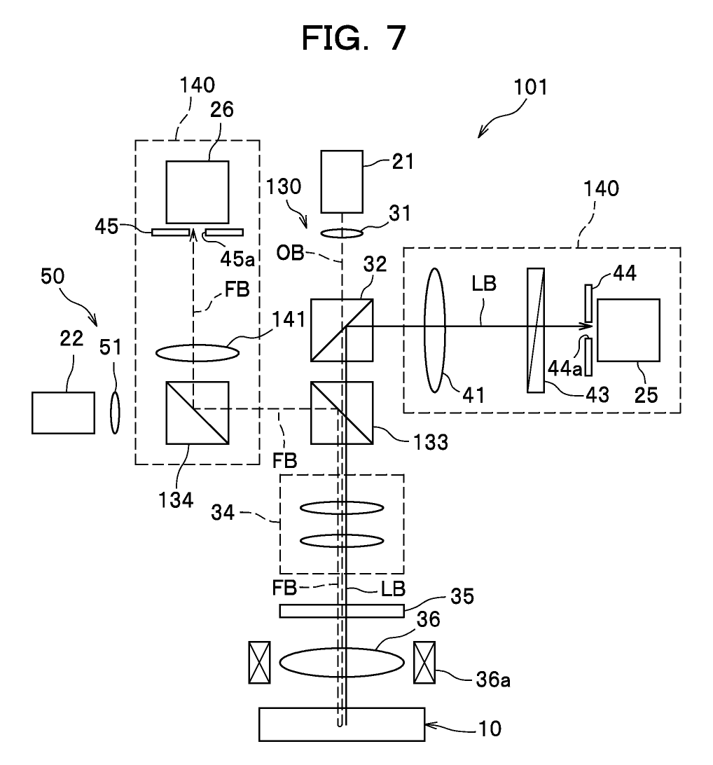

As shown in FIG. 7, when information is to be retrieved, the controller causes the laser 21 to emit a laser beam OB for retrieval, while rotating an optical storage medium 10 by the spindle. The laser beam OB passes through the beam splitter 32 and the polarized beam splitter 133, and then is expanded by the beam expander 34, converted into a circularly polarized light beam by the quarter-wave plate 35, and converged into a recording layer 14 of the optical storage medium 10 by the objective lens 36. In the optical storage medium 10, information is recorded by modulation of the presence or absence of a fluorescing property. When the laser beam OB is applied to a spot in the recording layer 14 where the fluorescing property is present, fluorescence is induced. Meanwhile, part of the laser beam OB reflects at an interface between the recording layer 14 on which the laser beam OB is focused and an intermediate layer 13 adjacent to this recording layer 14, and the direction of rotation of the electric field vector of its circular polarization is reversed (a light beam thus reflected will be referred to as reflected light beam FB). Part of the induced fluorescence and the reflected light beam FB travel in a direction opposite to a direction in which the laser beam OB has traveled toward the recording layer 14, and reach the objective lens 36. The reflected light beam FB is rendered parallel while passing through the objective lens 36, and converted into a linearly polarized state while passing through the quarter-wave plate 35. The reflected light beam FB then passes through the beam expander 34, and is reflected in the polarized beam splitter 133 in a direction deviated sideward. The reflected light beam FB thus deviated from the light path of the illumination optical system 130 by the polarized beam splitter 133 is further reflected sideward by the dichroic mirror 134, and passes through the condenser lens 141, by which the reflected light beam FB is converged to pass through the pinhole 45a and enter the photosensor 26 for reflected light. The photosensor 26 detects the reflected light beam FB and outputs a reflected light signal, which in turn is received and utilized for focus servo control by the controller.

On the other hand, the fluorescence is rendered parallel into a light beam while passing through the objective lens 36. This light beam derived from the fluorescence will be referred to as fluorescent light beam LB. The fluorescent light beam LB then passes through the quarter-wave plate 35 (with its unpolarized state unchanged) and the beam expander 34, and reaches the polarized beam splitter 133. At the polarized beam splitter 133, half of the fluorescent light beam LB is reflected in a direction deviated sideward from the light path of the illumination optical system 130, and passes through the condenser lens 41. Then, as in the first embodiment, the fluorescent light beam LB passes through the polarizer 43, comes into a focus at or near a position of the pinhole plate 44, passes through the pinhole 44a, and enters the photosensor 25 for signal retrieval. The photosensor 25 detects the fluorescent light beam LB and outputs a fluorescent light signal, which in turn is received by the controller in which information is demodulated therefrom by a known demodulation method.

As described above, in the apparatus 101 according to the present embodiment, the reflected light beam FB and the fluorescent light beam LB together travel toward the polarized beam splitter 133, but the reflected light beam FB is reflected and deviated (i.e., reflected light beam FB entering the photosensor 26 is attenuated) by the polarized beam splitter 133. Therefore, the fluorescent light beam LB having passed through the polarized beam splitter 133 has an improved S/N ratio. Isolation of the fluorescent light beam LB from the reflected light beam FB is achieved without utilizing the Stokes shift of the recording material, and it is thus ensured that the fluorescent light beam LB and the reflected light beam FB can be separated irrespective of the recording material used for the recording layer 14.

Although some exemplary embodiments of the present invention have been described above, the present invention is not limited to this embodiment, and may be carried out into practice in various other ways. Thus, it is contemplated that various modifications and changes may be made to the exemplary embodiments of the invention without departing from the scope of the embodiment of the present invention as defined in the appended claims.

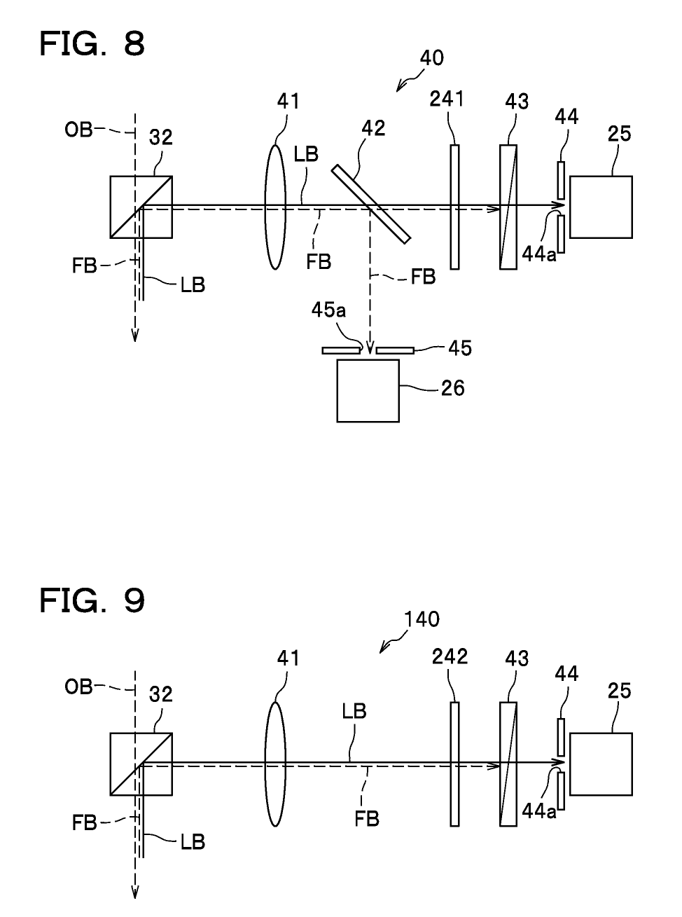

For example, in the above-described embodiments, isolation of the reflected light and the fluorescent light is not achieved by a filter using the Stokes shift, but such a filter may optionally be provided. For example, as shown in FIG. 8, the retrieval optical system 40 of the first embodiment may comprise a filter 241 disposed between the semitransparent mirror 42 and the polarizer 43. This filter 241 has a cutoff frequency corresponding to an appropriate wavelength which lies between the wavelength of the reflected light and the wavelength of the fluorescent light. When the reflected light beam FB and the fluorescent light beam LB pass through the filter 241, the reflected light beam FB only is attenuated by this filter 241, and the reflected light having passed through the filter 241 is further attenuated by the polarizer 43. Therefore, the S/N ratio of the fluorescent light to be detected can be increased further.

Similarly, as shown in FIG. 9, the retrieval optical system 140 of the second embodiment may comprise a filter 242 disposed between the condenser lens 41 and the polarizer 43. In this configuration, as well, the reflected light beam FB only is attenuated by the filter 242, and then further attenuated by the polarizer 43; thus, the S/N ratio of the fluorescent light to be detected can be increased further.

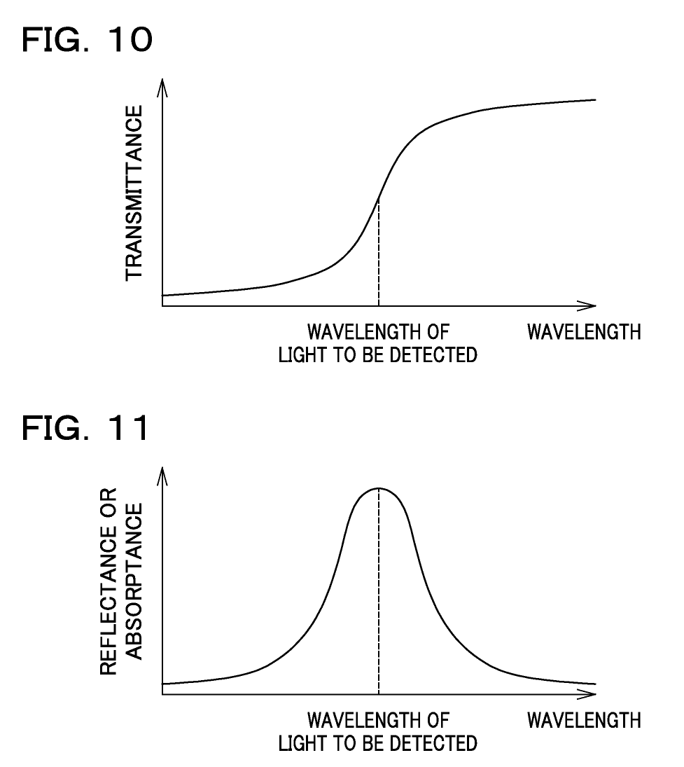

The characteristics of these filters 241 and 242 may be selected appropriately; for example, a high-pass filter having a transmittance characteristic as shown in FIG. 10 or a band-pass filter having a reflectance or absorptance characteristic as shown in FIG. 11 may preferably be adopted.

In the above-described embodiments, a light beam emitted for retrieval is a laser beam in a linearly polarized state, but the light beam for use in the retrieving process is not limited to such a laser beam. For example, in an alternative embodiment where light originated from a light-emitting element is not linearly polarized, an optical element configured to render the light into a linearly polarized state may be provided to realize a light source as consistent with the present invention. However, in order to retrieve information from a small segmented recording spot, it may be preferable that a laser beam that is coherent (i.e., of substantially the same wavelength and with a definite phase relationship) be adopted.

In the above-described embodiments, the light beam used in illuminating the recording layer to retrieve the information has a wavelength different from that of a light beam used in recording the information in the recording layer of the optical storage medium, but the light beams for retrieval and for recording may have the same wavelength. Furthermore, although the light source for retrieval and the light source for recording are provided separately in the above-described embodiments, one and the same light source configured to emit the light beam for retrieval and the light beam for recording may be provided, instead. In this alternative arrangement, the intensity of light beams emitted from the light source may be regulated such that the intensity of the light beam for retrieval is much weaker than the intensity of the light beam for recording, so that undesirable change in the recording material which would otherwise be effected during the retrieving process can be prevented.

In the above-described embodiments, the recording layer 14 is made of a recording material which is caused to change from a state without a fluorescing property to a state with a fluorescing property by irradiation with light, but the recording layer 14 may contrariwise be of a different type of recording material which is caused to change from a state with a fluorescing property to a state without a fluorescing property by irradiation with light.

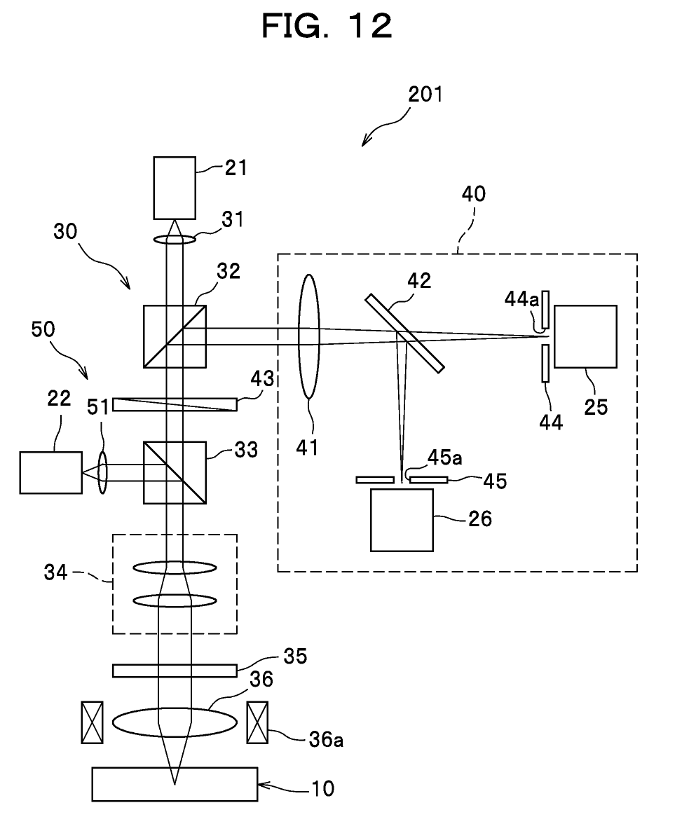

The polarizer may be provided in the illumination optical system instead of being provided in the retrieval optical system. For example, as in the apparatus 201 shown in FIG. 12, which is an exemplary embodiment modified from the first embodiment, the polarizer 43 may be between the beam splitter 32 and the dichroic mirror 33.

What is claimed is:

1. A method for retrieving information from an optical storage medium having a recording layer in which binary information is recorded in a form of presence or absence of a fluorescing property, comprising the steps of:
illuminating the recording layer with a light beam, to induce fluorescence in the recording layer;
isolating fluorescent light derived from the induced fluorescence, from light received from the optical storage medium, wherein the step of isolating fluorescent light comprises causing a polarized light separation element to attenuate a linearly polarized component of the light reflected in the optical storage medium; and
causing a photosensor to detect the isolated fluorescent light, to output a signal bearing the binary information recorded in the recording layer.

2. The method according to claim 1, wherein the step of isolating fluorescent light further comprises causing a polarizer to attenuate a linearly polarized component of light received from the polarized light separation element.

3. The method according to claim 1, wherein the recording layer comprises a material in which a multiple photon absorption reaction occurs upon irradiation with light, the multiple photon absorption reaction causing the material to change from a state without the fluorescing property to a state with the fluorescing property.

4. The method according to claim 1, wherein the light beam used to retrieve the information from the recording layer of the optical storage medium has a wavelength different from that of a light beam used to record the information in the recording layer of the optical storage medium.

5. An apparatus for retrieving information from an optical storage medium having a recording layer in which binary information is recorded in a form of presence and absence of a fluorescing property, comprising:
a light source configured to emit a light beam in a linearly polarized state;
an illumination optical system configured to converge the light beam emitted by the light source, into the recording layer of the optical storage medium, to induce fluorescence in the recording layer;
a beam splitter provided on a light path of the illumination optical system, and configured to cause a light beam coming from the optical storage medium to be deviated from the light path of the illumination optical system;
a retrieval optical system disposed to receive and converge the light beam deviated at the beam splitter, the retrieval optical system comprising a photosensor configured to detect fluorescent light derived from the induced fluorescence, in the light beam received and converged in the retrieval optical system, and to output a signal bearing the binary information recorded in the recording layer; and
a polarized light separation element provided in at least one of the illumination optical system and the retrieval optical system, and configured to attenuate reflected light derived from the light beam reflected in the optical storage medium, before the photosensor receives the fluorescent light.

6. The apparatus according to claim 5, further comprising a polarizer disposed downstream of the polarized light separation element on a path of the fluorescent light, and configured to further attenuate the reflected light.

7. The apparatus according to claim 5, further comprising:
a recording light source configured to emit a light beam for recording; and
a recording optical system configured to converge the light beam emitted by the recording light source, into the recording layer of the optical storage medium, to record the information therein.

8. The apparatus according to claim 7, wherein the light beam emitted by the light source to retrieve the recorded information has a wavelength different from that of the light beam emitted by the recording light source to record the information in the recording layer of the optical storage medium.

9. The apparatus according to claim 5, further comprising a member having a pinhole disposed in a position short of the photosensor and in vicinity of a focal point of the light beam converged in the retrieval optical system.
